(19) United States
(12) Patent Application Publication
(10) Pub. No.: US 2010/0138045 A1
(43) Pub. Date: Jun. 3, 2010

(54) MOTOR DRIVING DEVICE

(75) Inventor: HSIN-YEN CHAO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/339,060

(22) Filed: Dec. 19, 2008

(30) Foreign Application Priority Data
Dec. 3, 2008 (CN) 200810305932.1

(51) Int. Cl. H02P 29/00; G05B 13/02

(52) U.S. Cl. 700/275; 318/494

(57) ABSTRACT

A motor driving device for driving a motor includes a motor driver, a speed control loop, a current control loop, and an arithmetic selecting module. The motor driver provides a current signal for the motor to output a speed signal. The speed control loop receiving the speed signal and a speed command, includes a first selector and two first arithmetic modules. The current control loop receiving the current signal, includes a second selector and two second arithmetic modules. The arithmetic selecting module outputs a first select command and a second select command to select an arithmetic module of the speed control loop and the current control loop correspondingly. The speed control loop provides a current command for the current control loop and the arithmetic selecting module. The current control loop provides a control signal for the motor driver to adjust the current signal thereby to adjust the speed signal.

### BACKGROUND

1. Technical Field

The present disclosure relates to driving devices and, particularly, to a motor driving device.

2. Description of the Related Art

A general motor driving device is only capable of using a certain sort of arithmetic control process, such as proportional-integral (PI) arithmetic, proportional-derivative (PD) arithmetic, proportional-integral-derivative (PID) arithmetic, or fuzzy arithmetic and so on, to drive a motor. Different arithmetic control process controls different driving performance of the motor. For example, the PI arithmetic controls stable performance of the motor, and the PD arithmetic controls dynamic performance of the motor. However, invariable arithmetic control process is not capable of achieving a satisfying performance of the motor when load or operation environment of the motor is changed.

### BRIEF DESCRIPTION OF THE DRAWINGS

FIG. 1 is a block diagram of an exemplary embodiment of a motor driving device.

FIG. 2 is a block diagram of another exemplary embodiment of a motor driving device.

### DETAILED DESCRIPTION

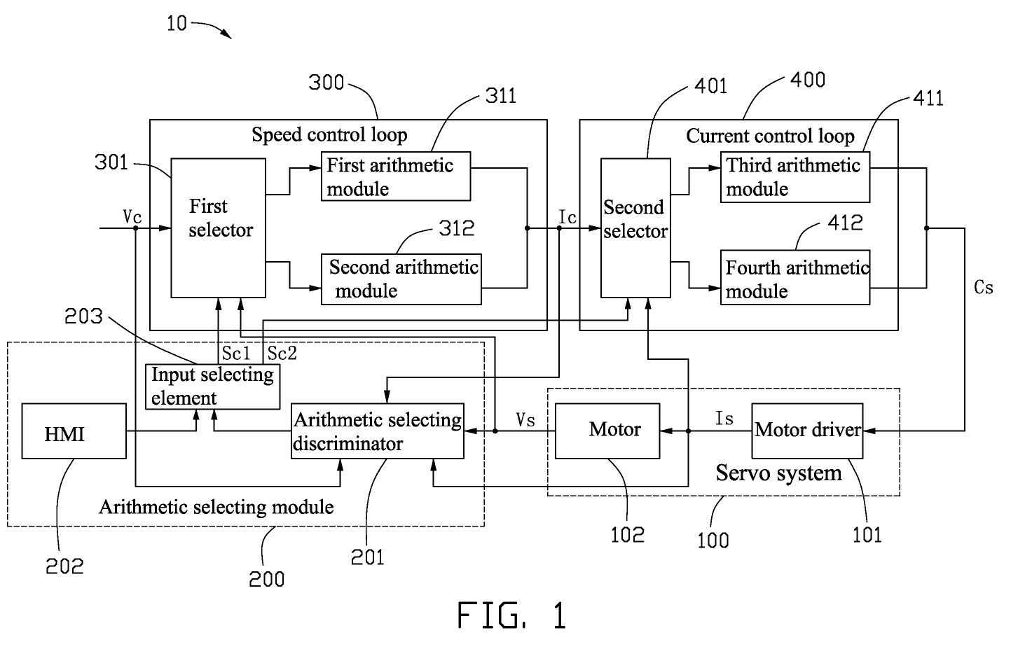

Referring to FIG. 1, an exemplary embodiment of a motor driving device 10 includes a servo system 100, an arithmetic selecting module 200, a speed control loop 300, and a current control loop 400.

The servo system 100 includes a motor driver 101 and a motor 102. The motor driver 101 is configured for driving the motor 102.

The arithmetic selecting module 200 includes an arithmetic selecting discriminator 201, a human-machine interface (HMI) 202, and an input selecting element 203. The input selecting element 203 is configured for selectively receiving selection commands of the arithmetic discriminator 201 or the HMI 202. The input selecting element 203 may be hardware, such as a single-pole double-throw (SPDT) switch, or may be software, such as a control program.

The speed control loop 300 includes a first selector 301, a first arithmetic module 311, and a second arithmetic module 312. The first selector 301 is configured for receiving a first selection command Sc1 output from the input selecting element 203, to select a corresponding arithmetic module from the first and second arithmetic modules 311 and 312 of the speed control loop 300. The first arithmetic module 311 and the second arithmetic module 312 are configured for storing different arithmetic control processes.

The current control loop 400 includes a second selector 401, a third arithmetic module 411, and a fourth arithmetic module 412. The second selector 401 is configured for receiving a second selection command Sc2 output from the input selecting element 203, to select a corresponding arithmetic module from the third and fourth arithmetic modules 411 and 412 of the current control loop 400. The third arithmetic module 411 and the fourth arithmetic module 412 are configured for storing different arithmetic control processes. In one exemplary embodiment, the speed control loop 300 and the current control loop 400 are two data processing chips.

The motor driver 101 is powered to provide a current signal Is for driving the motor 102. The motor 102 provides a speed signal Vs for the speed control loop 300 and the arithmetic selecting discriminator 201. Meanwhile, the current signal Is is provided for the current control loop 400 and the arithmetic selecting discriminator 201.

A speed command Vc is provided for the speed control loop 300 and the arithmetic selecting discriminator 201 when the motor driver 101 is powered. A speed value of the speed signal Vs of the motor 102 is about 0 at the beginning of powering the motor driver 101. Therefore, the HMI or the arithmetic selecting discriminator 201 can be selected manually or automatically via the input selecting element 203 to provide the first select command Sc1 for selecting an arithmetic module from the first and second arithmetic modules 311 and 312 of the speed control loop 300.

When the arithmetic selecting discriminator 201 is selected to provide the first select command Sc1 for the first selector 301, the arithmetic selecting discriminator 201 compares the speed command Vc with the speed signal Vs, and automatically selects, via the first selector 301, a arithmetic module from the first and second arithmetic modules 311 and 312 of the speed control loop 300 according to a speed difference of the speed command Vc and the speed signal Vs. For example, when the speed difference between the speed command Vc and the speed signal Vs is equal to or more than 0 rpm but less than 200 rpm, the arithmetic selecting discriminator 201 provides the first select command Sc1 for the first selector 301 to select the first arithmetic module 311; when the speed difference between the speed command Vc and the speed signal Vs is equal to or more than 200 rpm but less than or equal to 500 rpm, the arithmetic selecting discriminator 201 provides the first select command Sc1 for the first selector 301 to select the second arithmetic module 312.

The speed control loop 300 provides a current command Ic after the speed command Vc and the speed signal Vs are processed by the selected arithmetic module. The current command Ic is transmitted to the arithmetic selecting discriminator 201 and the current control loop 400.

The HMI 202 or the arithmetic selecting discriminator 201 can be selected manually or automatically via the input selecting element 203 to select an arithmetic module from the third and fourth arithmetic modules 411 and 412 of the current control loop 400. When the arithmetic selecting discriminator 201 is selected to provide the second select command Sc2 for the second selector 401, the arithmetic selecting discriminator 201 compares the current command Ic and the current signal Is, and automatically selects the arithmetic module from the third and fourth arithmetic modules 411 and 412 of the current control loop 400 according to a difference of the values of the current command Ic and the current signal Is. For example, when the difference between the current command Ic and the current signal Is is equal to or more than OA but less than 5 A, the arithmetic selecting discriminator 201 provides the second select command Sc2 for the second selector 401 to select the third arithmetic module 411; when the current difference between the current command Ic and the current signal Is is equal to or more than 5 A but less than or equal to 10 A, the arithmetic selecting discriminator 201 provides the second select command Sc2 for the second selector 401 to select the fourth arithmetic 412.

The current control loop 400 provides a control signal Cs for the motor driver 101 after the current command Ic and the current signal Is are processed by the selected arithmetic module of the current control loop 400, for adjusting the current signal Is, thereby adjusting the speed signal Vs of the motor 102.

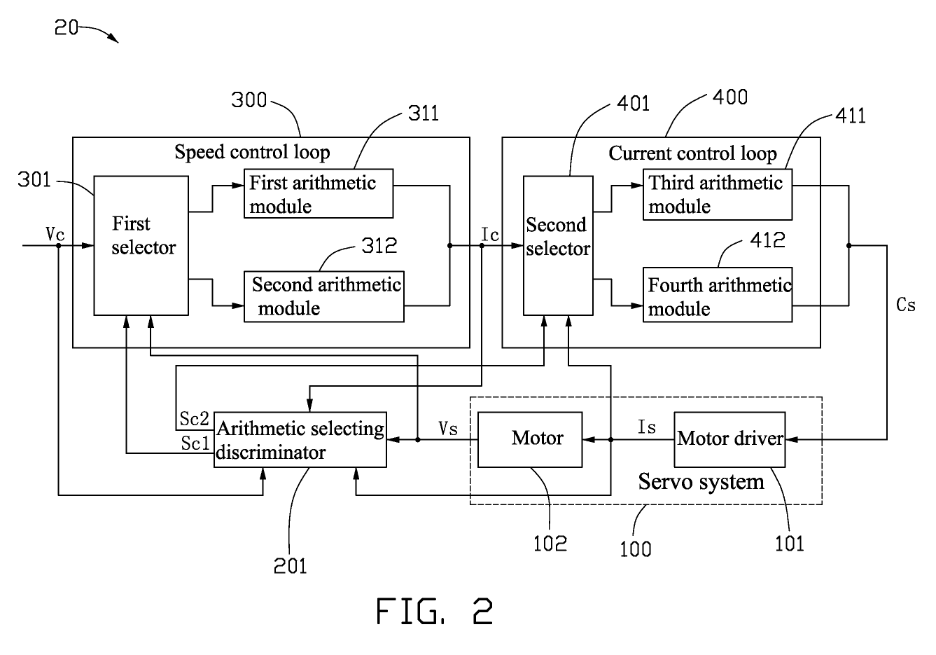

In one exemplary embodiment, the HMI 202 can be operated to transmit the first select command Sc1 to select an arithmetic module from the first and second arithmetic modules 311 and 312 of the speed control loop 300, and transmit the second select command Sc2 to select an arithmetic module from the third and fourth arithmetic modules 411 and 412 of the current control loop 400 manually at the beginning of powering the motor driver 101. However, the disclosure is not limited thereto. The arithmetic selecting discriminator 201 is also capable of directly transmitting the select command Sc1 and the second select command Sc2 automatically at the beginning of powering the motor driver 101. Therefore, the HMI 202 and the input selecting element 203 can be omitted in another exemplary embodiment, which is illustrated in FIG. 2.

In one exemplary embodiment, the speed control loop 300 and the current control loop 400 may each include more than two arithmetic modules. In another embodiment, the speed control loop 300 may include only one arithmetic module while the current control loop 400 may include more than one arithmetic module, or vice versa.

In one exemplary embodiment, other control loops of the servo system 100 can be controlled by the motor driving device 10, such as a pressure control loop and a voltage control loop of the servo system 400, each of which may include more than one arithmetic module storing different arithmetic control processes.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A motor driving device for driving a motor, comprising:
a motor driver configured for driving the motor, wherein the motor driver provides a current signal for the motor, and the motor outputs a speed signal;
an arithmetic selecting module connected to the motor and the motor driver, and configured for receiving a speed command, the speed signal and the current signal, and providing a first select command and a second select command;
a speed control loop configured for receiving the speed signal and the speed command, the speed control loop comprising:
at least two first arithmetic modules, wherein the at least two first arithmetic modules are configured for storing different arithmetic control processes respectively; and
a first selector configured for receiving the first select command, the speed signal and the speed command, and selecting one first arithmetic module from the at least two first arithmetic modules of the speed control loop according to the first select command for processing the speed command and the speed signal; wherein the speed control loop outputs a current command after the speed command and the speed signal are processed by the selected first arithmetic module of the speed control loop; and
a current control loop configured for receiving the current signal of the motor driver and the current command from the speed control loop, the current control loop comprising:
at least two arithmetic modules, wherein the at least two second arithmetic modules are configured for storing different arithmetic control processes; and
a second selector configured for receiving the second select command, the current signal and the current command, and selecting one second arithmetic module from the at least two second arithmetic modules of the current control loop according to the second select command for processing the current signal and the current command; wherein the current control loop outputs a control signal for the motor driver after the current signal and the current command are processed by the selected second arithmetic module of the current control loop, to adjust the current signal of the motor driver, therefore to adjust the speed signal of the motor.

2. The motor driving device of claim 1, wherein the arithmetic selecting module comprises an arithmetic selecting discriminator configured for providing the first select command for the first selector to select a corresponding first arithmetic module of the speed control loop according to a speed difference between the speed command and the speed signal, and providing the second select command for the second selector to select a corresponding second arithmetic module of the current control loop according to a current difference between the current command and the current signal.

3. The motor driving device of claim 1, wherein the arithmetic selecting module comprises a human-machine interface (HMI), an arithmetic selecting discriminator, and an input selecting element; wherein the input selecting element is configured for selecting the HMI or the arithmetic selecting discriminator to provide the first select command and the second select command for the first selector and the second selector correspondingly; wherein the arithmetic selecting discriminator is capable of providing the first select command for the first selector according to a speed difference between the speed command and the speed signal, and providing the second select command for the second selector according to a current difference between the current command and the current signal.

4. A motor driving device for driving a motor, comprising:
a motor driver configured for driving the motor, wherein the motor driver provides a current signal for the motor, and the motor outputs a speed signal;
an arithmetic selecting module connected to the motor and the motor driver, and configured for receiving a speed command, the speed signal and the current signal, and providing a select command;
a speed control loop configured for receiving the speed signal and the speed command, and comprising a first arithmetic module configured for storing a kind of arithmetic control processes to process the speed signal and the speed command; wherein the speed control loop outputs a current command after the speed signal and the speed command are processed by the first arithmetic module of the speed control loop; and
a current control loop configured for receiving the current signal of the motor driver and the current command from the speed control loop, comprising:
at least two second arithmetic modules, wherein the at least two arithmetic modules are configured for storing different kinds of arithmetic control processes respectively; and
a selector configured for receiving the select command, the current signal and the current command, and selecting one second arithmetic module from the at least two second arithmetic modules of the current control loop according to the select command for processing the current signal and the current command; wherein the current control loop outputs a control signal for the motor driver after the current signal and the current command are processed by the selected second arithmetic module of the current control loop, to adjust the current signal of the motor driver thereby adjusting the speed signal of the motor.

5. The motor driving device of claim 4, wherein the arithmetic selecting module comprises an arithmetic selecting discriminator configured for providing the select command for the selector to select a corresponding second arithmetic module of the current control loop according to a current difference between the current command and the current signal.

6. The motor driving device of claim 4, wherein the arithmetic selecting module comprises a human-machine interface (HMI), an arithmetic selecting discriminator, and an input selecting element; wherein the input selecting element is configured for selecting the HMI or the arithmetic selecting discriminator to provide the select command for the selector of the current control loop; wherein the arithmetic selecting discriminator is capable of providing the select command for the selector according to a current difference between the current command and the current signal.

7. A motor driving device for driving a motor, comprising:
a motor driver configured for driving the motor, wherein the motor driver provides a current signal for the motor, and the motor outputs a speed signal;
an arithmetic selecting module connected to the motor and the motor driver, configured for receiving a speed command, the speed signal and the current signal, and providing a select command;
a speed control loop configured for receiving the speed signal and the speed command, wherein the speed control loop comprises:
at least two first arithmetic modules, wherein the at least two first arithmetic modules are configured for storing different kinds of arithmetic control processes; and
a selector configured for receiving the select command, the speed signal and the speed command, and selecting one first arithmetic module from the at least two first arithmetic modules of the speed control loop according to the select command for processing the speed command and the speed signal; wherein the speed control loop outputs a current command after the speed command and the speed signal are processed by a selected first arithmetic module of the speed control loop; and
a current control loop configured for receiving the current signal of the motor driver and the current command from the speed control loop, and comprising a second arithmetic module configured for storing arithmetic control processes to process the current command and the current signal; wherein the current control loop outputs a control signal for the motor driver after the current signal and the current command are processed by the second arithmetic module of the current control loop, to adjust the current signal of the motor driver thereby adjusting the speed signal of the motor.

8. The motor driving device of claim 7, wherein the arithmetic selecting module is an arithmetic selecting discriminator configured for providing the select command for the selector to select an arithmetic module of the speed control loop according to a speed difference of the speed command and the speed signal.

9. The motor driving device of claim 7, wherein the arithmetic selecting module comprises a human-machine interface (HMI), an arithmetic selecting discriminator, and an input selecting element; wherein the input selecting element is configured for selecting the HMI or the arithmetic selecting discriminator to provide the select command for the selector of the speed control loop; wherein the arithmetic selecting discriminator is capable of providing the select command for the selector according to a speed difference between the speed command and the speed signal.
